(19) United States
(12) Patent Application Publication
(10) Pub. No.: US 2005/0129985 A1
(43) Pub. Date: Jun. 16, 2005

(54) Perpendicular magnetic recording media

(75) Inventors: Hoon-sang Oh, Seongnam-si (KR); Byung-kyu Lee, Seoul (KR); Kyung-jin Lee, Suwon-si (KR); Soo-youl Hong, Santa Clara, CA (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/008,179

(22) Filed: Dec. 10, 2004

(30) Foreign Application Priority Data
Dec. 10, 2003 (KR) 2003-89364

(51) Int. Cl. G11B 5/64

(52) U.S. Cl. 428/694 TS; 428/336

(57) ABSTRACT

A perpendicular magnetic recording medium having a perpendicular magnetic recording layer provided on a substrate and a soft underlayer formed between the substrate and the perpendicular magnetic recording layer. The soft underlayer includes a plurality of soft underlayers having different saturation magnetizations so as to improve signal-to-noise ratio, and at least one of the soft underlayers has a magnetization easy axis in a radial direction so as to improve transition noise.

### BACKGROUND OF THE INVENTION

This application claims the priority of Korean Patent Application No. 2003-89364, filed on Dec. 10, 2003, in the Korean Intellectual Property Office, the disclosure of which is incorporated herein in its entirety by reference.

1. Field of the Invention

The present invention relates to a perpendicular magnetic recording medium, and more particularly, to a perpendicular magnetic recording medium for improving signal-to-noise ratio (SNR).

2. Description of the Related Art

Hard disk drives (HDDs), which are representative magnetic information storage media and which lead a rapid increase in recording density, are currently adopting longitudinal magnetic recording methods involving ring type head and longitudinal magnetic recording media. Conventional longitudinal magnetic recording methods, however, are limited in increasing recording density because of thermal instability of a recording medium, and a new recording method, the perpendicular magnetic recording method, is currently being actively developed.

The recording density of a present day longitudinal magnetic recording type HDD product is about 90-100 Gb/in². It is expected that the recording density of a perpendicular magnetic recording type HDD could be higher than 200 Gb/in² and up to 500 Gb/in².

A perpendicular magnetic recording method increases recording density by arranging the magnetic direction of unit bits, which are recorded on a medium, in a perpendicular direction. When such a perpendicular magnetic recording method is applied, data stability improves in spite of the decrease in bit size.

The perpendicular magnetic recording method uses a perpendicular magnetic recording medium having a double magnetic layer structure. In other words, a soft underlayer is added under a recording layer in a perpendicular magnetic recording medium in order to carry out perpendicular magnetic recording.

Referring to FIG. 1, a conventional perpendicular magnetic recording medium 10 includes a substrate 11, a perpendicular magnetic recording layer 17 on which magnetic data is recorded by a writing head, and a perpendicular alignment underlayer 15, which is formed before depositing the perpendicular magnetic recording layer 17 to improve the crystalline alignment and the magnetic characteristic of the perpendicular magnetic recording layer 17. In addition, the perpendicular magnetic recording medium 10 includes a soft underlayer 13 formed under the perpendicular alignment underlayer 15 in order to increase the strength and spatial change rate of a magnetic field, which is generated from a pole type writing head, in a magnetic recording mode. The conventional perpendicular magnetic recording medium 10 is formed by sequentially stacking the soft underlayer 13, the perpendicular alignment underlayer 15, the perpendicular magnetic recording layer 17, and a protection layer 19, on the substrate 11.

Here, the perpendicular alignment underlayer 15 may be referred to as an intermediate layer.

In the perpendicular magnetic recording medium 10 having a double magnetic layer structure, the soft underlayer 13 is important for performing high density recording.

FIG. 2 is a sectional view illustrating a perpendicular magnetic recording system using a conventional perpendicular magnetic recording medium 10. A magnetic head 30 for writing and reading information on and from the perpendicular magnetic recording medium 10 includes a writing head 31 having a writing pole 33 and a return pole 35 for writing magnetic information on a recording layer 17, and a reading head 37, in other words, a magnetic resistance head for reading magnetic information recorded on the recording layer 17. The structure of the magnetic head 30 for the perpendicular magnetic recording medium 10 is widely known, thus a further detailed description thereof will be omitted.

When a soft underlayer 13 is formed under the recording layer 17, a virtual image head corresponding to the pole structure of the writing head 31 is formed in the soft underlayer 13. Thus, a strong and sharp recording magnetic field is obtained compared to the case where the soft underlayer 13 is absent. The field strength is about doubled and a field gradient is increased by three to four times by forming the soft underlayer 13.

Due to use of the soft underlayer 13, a recording operation can be performed even when the recording layer 17 is formed of a material having high anisotropy magnetic field and coercive force. Accordingly, recording density is largely improved.

As described above, the soft underlayer 13 is essential for realizing the merits of the perpendicular magnetic recording method.

However, the soft underlayer 13 is formed of a magnetic substance, for example, a ferromagnetic substance. Thus, magnetic field leaking from the surface of the soft underlayer 13 is detected by the reading head 37. The magnetic field thus operates as a noise source to deteriorate the SNR.

In addition, when an unstable domain wall exists in the soft underlayer 13, such a domain wall interacts with a bit transition area recorded on the recording layer 17. This results in an increase in transition noise as one type of noise generated from the recording layer 17.

### SUMMARY OF THE INVENTION

The present invention provides a perpendicular magnetic recording medium for obtaining an improved signal-to-noise ratio (SNR) by changing the composition of a soft underlayer.

According to a first aspect, the present invention provides a perpendicular magnetic recording medium comprising a perpendicular magnetic recording layer on a substrate and a soft underlayer formed between the substrate and the perpendicular magnetic recording layer, wherein the soft underlayer includes a plurality of soft underlayers having different saturation magnetizations, and at least one of the soft underlayers has a magnetization easy axis in a radial direction.

The soft underlayer may include a first soft underlayer and a second soft underlayer closer to the perpendicular magnetic recording layer than the first soft underlayer, the second soft underlayer having a larger saturation magnetization than that of the first soft underlayer.

The soft underlayer may include a first soft underlayer and a second soft underlayer closer to the perpendicular magnetic recording layer than the first soft underlayer, the second soft underlayer having a smaller saturation magnetization than that of the first soft underlayer.

The thickness of the second soft underlayer may be less than the thickness of the first soft underlayer.

The thickness of the second soft underlayer may be 1 nm or more and 50 nm or less.

The entire thickness of the soft underlayer may be 200 nm or less, and the thickness of the second soft underlayer closer to the perpendicular magnetic recording layer may be 50 nm or less.

According to another aspect, the present invention provides a perpendicular magnetic recording medium comprising a perpendicular magnetic recording layer on a substrate and a soft underlayer formed between the substrate and the perpendicular magnetic recording layer, wherein the soft underlayer includes a plurality of soft underlayers having different saturation magnetizations, and the entire thickness of the soft underlayers is 200 nm or less while the thickness of the soft underlayer closer to the perpendicular magnetic recording layer is 50 nm or less.

At least one of the soft underlayers may have a magnetization easy axis in a radial direction.

The soft underlayer may be formed of a ferromagnetic substance or the combination of an antiferromagnetic substance and a ferromagnetic substance.

The soft underlayer may include one or more alloys selected from the group consisting of a NiFe-based alloy, an Fe-based alloy and a Co-based alloy.

The soft underlayer may include an alloy selected from the group consisting of NiFe, NiFeNb, NiFeCr, and a ternary or quaternary alloy thereof, FeAlSi, FeTaC, FeTaN, and a quaternary alloy thereof, and CoFe, CoZrNb, CoZrTa, and a ternary or quaternary alloy thereof.

The perpendicular magnetic recording medium may further comprise a perpendicular alignment underlayer between the soft underlayer and the perpendicular magnetic recording layer to improve the crystalline alignment of the perpendicular magnetic recording layer.

### BRIEF DESCRIPTION OF THE DRAWINGS

The above and other features and advantages of the present invention will become more apparent by describing in detail an exemplary embodiment thereof with reference to the attached drawings in which:

FIG. 1 is a sectional view illustrating the structure of a conventional perpendicular magnetic recording medium;

FIG. 2 is a sectional view illustrating a perpendicular magnetic recording system using a perpendicular magnetic recording medium;

FIG. 3 is a sectional view illustrating the structure of a perpendicular magnetic recording medium according to a first embodiment of the present invention;

FIG. 4 is a plane view illustrating a magnetization easy axis of a soft underlayer of the perpendicular magnetic recording medium of FIG. 3;

FIG. 5 is a perspective view illustrating a soft underlayer and a perpendicular magnetic recording layer used in simulations;

FIG. 6A is a sectional view illustrating a first example of a soft underlayer, which is formed of a single layer having a small magnetization saturation of 600 emu/cm³;

FIG. 6B is a sectional view illustrating a second example of a soft underlayer, which is formed of a first soft underlayer having a magnetization saturation of 1,000 emu/cm³ and a second soft underlayer having a saturation magnetization of 600 emu/cm³, namely, the saturation magnetization of the second soft underlayer closer to a perpendicular magnetic recording layer is smaller than that of the first soft underlayer;

FIG. 6C is a sectional view illustrating a third example of a soft underlayer, which is formed of a single layer having a large saturation magnetization of 1,000 emu/cm³;

FIG. 6D is a sectional view illustrating a fourth example of a soft underlayer, which is formed of a first soft underlayer having a saturation magnetization of 600 emu/cm³ and a second soft underlayer having a saturation magnetization of 1,000 emu/cm³, namely, the saturation magnetization of the second soft underlayer closer to a perpendicular magnetic recording layer is larger than that of the first soft underlayer;

FIG. 7 is a graph illustrating signal-to-noise ratios (SNR) of the first through fourth examples of FIGS. 6A through 6D predicted by micromagnetic simulation; and

FIGS. 8A through 8D are graphs illustrating changes in the SNRs of a perpendicular magnetic recording layer only (RL), an uppermost underlayer only (Top SUL), both first and second soft underlayers (SUL(sum)), and both a perpendicular magnetic recording layer and first and second soft underlayers (Total), in the first through fourth examples of FIGS. 6A through 6D, respectively.

### DETAILED DESCRIPTION OF THE INVENTION

The present invention will now be described more fully with reference to the accompanying drawings, in which an exemplary embodiment of the invention is shown. However, the present invention should not be construed as being limited thereto.

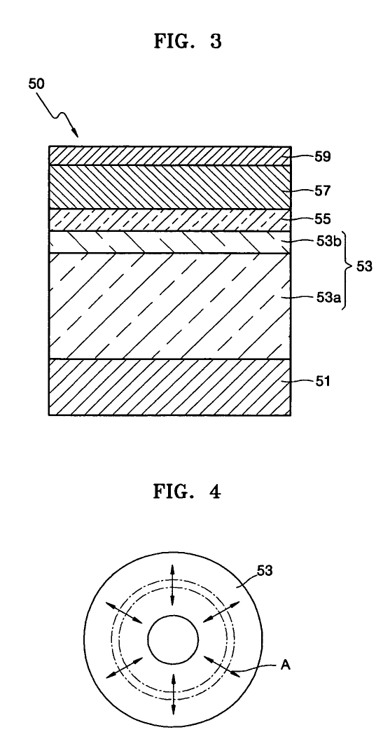

FIG. 3 is a sectional view illustrating the structure of a perpendicular magnetic recording medium 50 according to a first embodiment of the present invention.

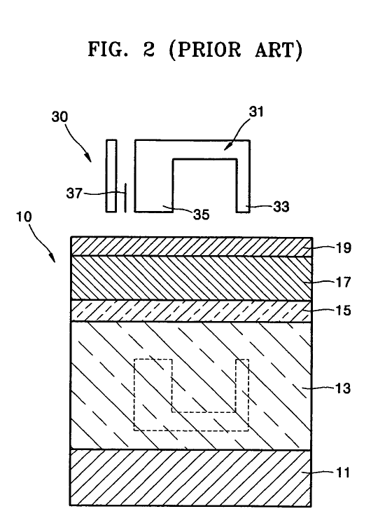

Referring to FIG. 3, a perpendicular magnetic recording medium 50 includes a perpendicular magnetic recording layer 57 formed on a substrate 51, and a soft underlayer 53 formed between the substrate 51 and the perpendicular magnetic recording layer 57. In addition, the perpendicular magnetic recording medium 50 according to the first embodiment of the present invention may further include a perpendicular alignment underlayer 55 between the soft underlayer 53 and the perpendicular magnetic recording layer 57. A protection layer 59 for protecting the perpendicular magnetic recording layer 57 from the outside may be formed on the perpendicular magnetic recording layer 57. In addition, a lubrication layer (not shown) for reducing abrasion of a magnetic head 30 of FIG. 2 and the protection layer 59 caused by the contact with the magnetic head 30 of FIG. 2 may be further formed on the protection layer 59.

Information is recorded on the perpendicular magnetic recording layer 57 by arranging the magnetization direction of unit bits, which are recorded by the operation of a writing head 31 of a magnetic head 30 of FIG. 2, in a perpendicular direction. Here, the perpendicular magnetic recording layer 57 is formed of a Co-based and/or Fe-based alloy ferromagnetic substance having excellent perpendicular magnetic anisotropy, for example, CoCrPtX (X═Nb, B, Ta, SiOx, O) or an ordered L10 type FePt alloy.

The perpendicular alignment underlayer 55, in other words, an intermediate layer, is formed to improve the crystalline alignment and the magnetic characteristic of the perpendicular magnetic recording layer 57. The perpendicular alignment underlayer 55 provides magnetic severance from the soft underlayer 53. The perpendicular alignment underlayer 55 is formed to be as thin as possible.

The soft underlayer 53 includes a plurality of soft underlayers having different saturation magnetizations, for example, first and second soft underlayers 53a and 53b.

At least one of the first and second soft underlayers 53a and 53b is formed to have a magnetization easy axis A in a radial direction as shown in FIG. 4. In addition, the second soft underlayer 53b, which is closer to the perpendicular magnetic recording layer 57 than the first soft underlayer 53a, may be formed to have a smaller thickness than the first soft underlayer 53a. The soft underlayer 53 including the first and second soft underlayers 53a and 53b may be formed of a ferromagnetic substance. In another case, the soft underlayer 53 may be formed of the combination of an antiferromagnetic substance and a ferromagnetic substance. That is, the first and second soft underlayers 53a and 53b may be formed of a ferromagnetic substance on an antiferromagnetic substance, such as FeMn, IrMn, or PtMn.

When the first and second soft underlayers 53a and 53b are formed in a state in which a magnetic field is generated in a radial direction, the first and second soft underlayers 53a and 53b having an easy axis in the radial direction are obtained. Since the perpendicular magnetic recording medium 53 is manufactured in a circular shape and used in an HDD, the soft underlayer 53 of the perpendicular magnetic recording medium 50 is shown in a circular shape, in FIG. 4. Here, the radial direction denotes a central axis direction or an outer diameter direction of the disk shaped perpendicular magnetic recording medium 50.

When the first and second soft underlayers 53a and 53b are formed to align the easy axis A in the radial direction with sufficient anisotropy field Hk, a domain wall is absent in the first and second soft underlayers 53a and 53b. Thus, a transition noise problem due to the domain wall does not occur.

The thickness of the soft underlayer 53 is 200 nm or less, and the thickness of the soft underlayer closer to the perpendicular magnetic recording layer 57, that is, the second soft underlayer 53b, is 50 nm or less. The thickness of the second soft underlayer 53b is 1 nm or more and 50 nm or less, for example, 10 nm or more and 50 nm or less, and must be less than the thickness of the first soft underlayer 53a.

The soft underlayer 53 may include one or more alloys selected from the group consisting of a NiFe-based alloy, an Fe-based alloy and a Co-based alloy. More specifically, the soft underlayer 53 may include an alloy selected from the group consisting of NiFe, NiFeNb, NiFeCr, and a ternary or quaternary alloy thereof, FeAlSi, FeTaC, FeTaN, and a quaternary alloy thereof, and CoFe, CoZrNb, CoZrTa, and a ternary or quaternary alloy thereof.

On the other hand, the second soft underlayer 53b may have a larger saturation magnetization than the first soft underlayer 53a.

As described in the following examples, when the saturation magnetization of the second soft underlayer 53b is larger than the first soft underlayer 53a, the signal-to-noise ratio (SNR) is improved. Thus, the perpendicular magnetic recording medium 50 according to the present invention may include a second soft underlayer 53b having a larger saturation magnetization than the first soft underlayer 53a.

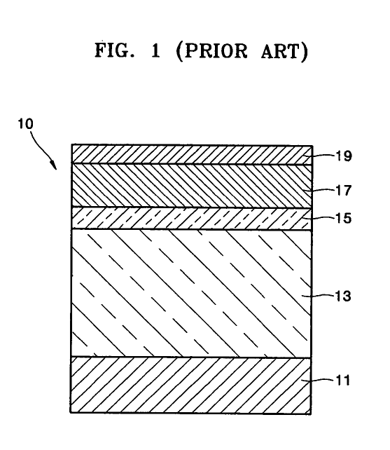

Even when the saturation magnetization of the second soft underlayer 53b is less than that of the first soft underlayer 53a, the SNR is superior to the case of a single layer soft underlayer 13 of a conventional perpendicular magnetic recording medium 10 of FIG. 1. Thus, the perpendicular magnetic recording medium 50 according to the present invention may include a second soft underlayer 53b having a lower saturation magnetization than the first soft underlayer 53a.

The perpendicular magnetic recording medium 50 according to the present invention having a plurality of soft underlayers 53a and 53b having different saturation magnetizations can provide a SNR higher than that of a conventional perpendicular magnetic recording medium.

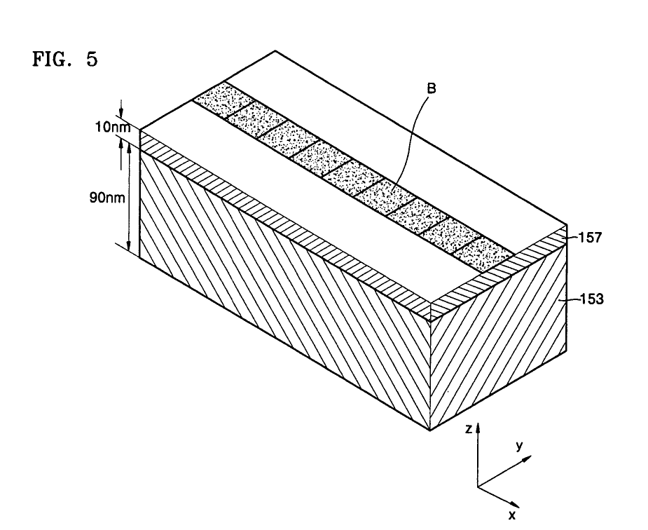

FIG. 5 is a perspective view illustrating a soft underlayer 153 and a perpendicular magnetic recording layer 157 used in simulations. The simulations are performed to examine the effect of the soft underlayer 153 on SNR. Here, the existence of a perpendicular alignment underlayer is ignored.

In the simulations, the perpendicular magnetic recording layer 157 is formed of a CoCrPtX material to a thickness of 10 nm and the soft underlayer 153 is formed to a thickness of 90 nm to have a saturation magnetization Ms of 600 and/or 1,000 emu/cm³. In addition, a bit pattern B having a width of 100 nm and a length of 30 nm is formed on the perpendicular magnetic recording layer 157. When the length of a bit is 30 nm, a linear recording density of the bit is 800 kfci (kilo flux reversal per inch).

The formation conditions of the perpendicular magnetic recording layer 157 are a saturation magnetization Ms of 550 emu/cm³, an axis magnetic anisotropy Ku of 3.5×106 erg/cm³, an exchange coupling A* of 0 erg/cm, Δθ of 10°, and α of 0.05.

Here, the exchange coupling A* is a constant denoting the interaction among grains in the perpendicular magnetic recording layer 157, and a smaller exchange coupling value is better.

Δθ denotes the tilt amount of the aligned direction of the grains, and a smaller Δθ value is better.

α denotes a magnetic damping constant. When a magnetic field is applied, a spin-up or spin-down is carried out through precession. As the α value is reduced, the spin-up or spin-down is carried out at a high speed.

The formation conditions of the soft underlayer 153 are a saturation magnetization Ms of 600 and/or 1,000 emu/cm³, Hk of 10 Oe, Hex of 0, an easy axis of the Y-axis in FIG. 5, and α of 0.05.

Here, the Y-axis operating as the easy axis corresponds to a radial direction. In this case, the X-axis corresponds to a track direction. As described above, when the soft underlayer 153 is formed while applying the magnetic field in the radial direction, the easy axis is formed in the radial direction.

Hk denotes a field to be applied from the outside in order to align the spin in a magnetization hard axis. As the Hk value increases, a larger magnetic field is required to align the spin from the easy axis to the hard axis.

Hex denotes an exchange field, and zero Hex means that an antiferromagnetic substance is not used to form the soft underlayer 153. The soft underlayer 153 may be formed by arranging a ferromagnetic substance on an antiferromagnetic substance. In this case, the antiferromagnetic substance leads the spin of the ferromagnetic substance in a predetermined direction.

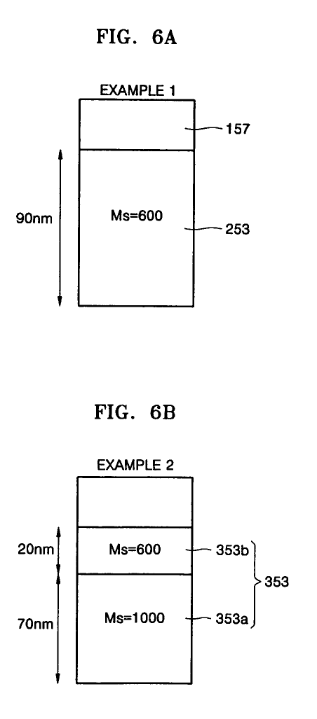

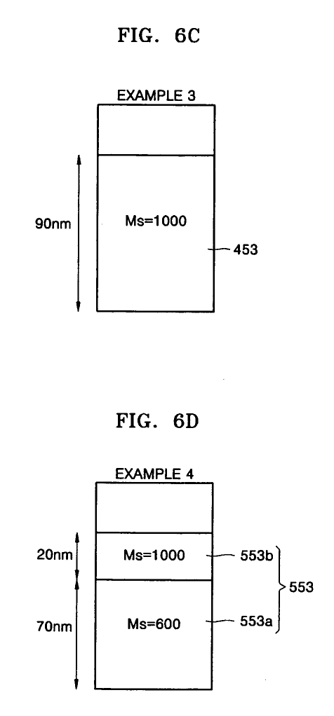

The simulations are performed on the four cases shown in FIGS. 6A through 6D.

Referring to FIG. 6A of a first example, a soft underlayer 253 is formed as a single layer having a small saturation magnetization Ms of 600 emu/cm³.

Referring to FIG. 6B of a second example, a soft underlayer 353 is formed of a first soft underlayer 353a having a saturation magnetization Ms of 1,000 emu/cm³ and a second soft underlayer 353b having a saturation magnetization Ms of 600 emu/cm³. That is, the saturation magnetization of the second soft underlayer 353b closer to a perpendicular magnetic recording layer 157 is smaller than the saturation magnetization of the first soft underlayer 353a.

Referring to FIG. 6C of a third example, a soft underlayer 453 is formed as a single layer having a large saturation magnetization Ms of 1,000 emu/cm³.

Referring to FIG. 6D of a fourth example, a soft underlayer 553 is formed of a first soft underlayer 553a having a saturation magnetization Ms of 600 emu/cm³ and a second soft underlayer 553b having a saturation magnetization Ms of 1,000 emu/cm³. That is, the saturation magnetization of the second soft underlayer 553b closer to a perpendicular magnetic recording layer 157 is larger than the saturation magnetization of the first soft underlayer 553a.

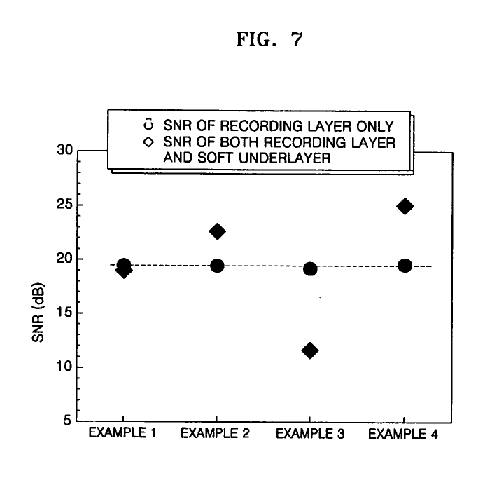

FIG. 7 is a graph illustrating SNRs of the first through fourth examples of FIGS. 6A through 6D. In the graph of FIG. 7, the SNRs of the perpendicular magnetic recording layers only and the SNRs of both the perpendicular magnetic recording layer and the soft underlayers are shown.

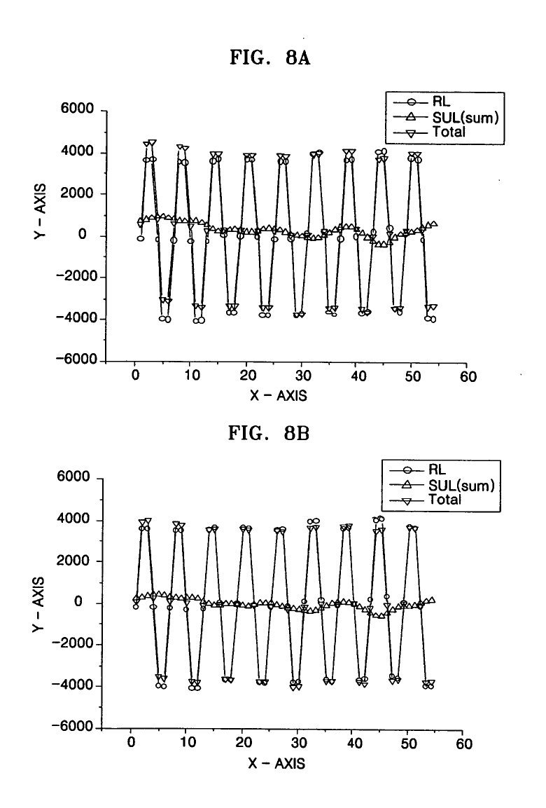

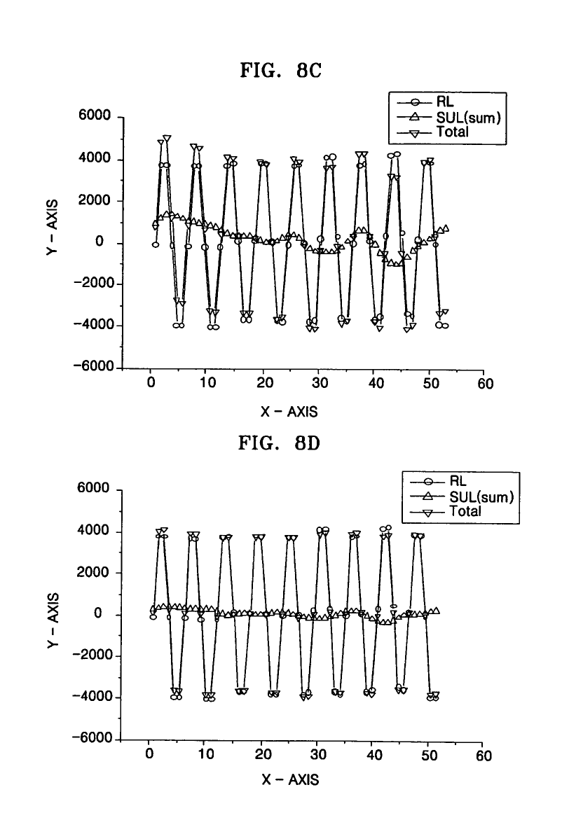

FIGS. 8A through 8D are graphs illustrating changes in the SNRs of a perpendicular magnetic recording layer only RL, first and second soft underlayers SUL(sum), and both a perpendicular magnetic recording layer and first and second soft underlayers Total, in the first through fourth examples of FIGS. 6A through 6D, respectively. The X-axis in FIGS. 8A through 8D is the same axis as the X-axis of FIG. 5, which denotes a track direction of recording magnetic information. The Y-axis in FIGS. 8A through 8D denotes the signals generated from the bits, which are recorded by moving a reading head to the X-axis of FIG. 5. More specifically, the reading head has a fixed position, but the recording medium is rotated.

As shown in the graphs of FIGS. 7 and 8A through 8D, the SNRs of the perpendicular magnetic recording layers are the same in the first through fourth examples. However, the SNRs of both the perpendicular magnetic recording layers and the soft underlayers vary among the first through fourth examples.

When the soft underlayer is formed as a single layer, the SNR may be deteriorated compared to the SNR of the perpendicular magnetic recording layer only, as in the cases of the first and third examples. However, when the soft underlayer is formed as a double-layer having different saturation magnetizations, the SNR is improved compared to the SNR of the perpendicular magnetic recording layer only, as in the cases of the second and fourth examples. More specifically, when the saturation magnetization of the second soft underlayer closer to the perpendicular magnetic recording layer is larger than the saturation magnetization of the first soft underlayer as in the case of the fourth example, the SNR is increasingly improved.

Thus, since a perpendicular magnetic recording layer according to the present invention includes a soft underlayer formed of a first and second soft underlayers having different saturation magnetizations, the SNR is improved.

In addition, the soft underlayer is formed to have an easy axis in a radial direction, thus transition noise is increasingly improved.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

1. A perpendicular magnetic recording medium comprising:
a perpendicular magnetic recording layer provided on a substrate; and
a soft underlayer formed between the substrate and the perpendicular magnetic recording layer, wherein
the soft underlayer comprises a plurality of soft underlayers having different saturation magnetizations, and at least one of the soft underlayers has a magnetization easy axis in a radial direction.

2. The perpendicular magnetic recording medium of claim 1, wherein the soft underlayer comprises:
a first soft underlayer; and
a second soft underlayer arranged closer to the perpendicular magnetic recording layer than the first soft underlayer, the second soft underlayer having a larger saturation magnetization than the first soft underlayer.

3. The perpendicular magnetic recording medium of claim 2, wherein the thickness of the second soft underlayer is less than the thickness of the first soft underlayer.

4. The perpendicular magnetic recording medium of claim 3, wherein the thickness of the second soft underlayer is 1 nm or more and 50 nm or less.

5. The perpendicular magnetic recording medium of claim 3, wherein the entire thickness of the soft underlayer is 200 nm or less, and the thickness of the second soft underlayer closer to the perpendicular magnetic recording layer is 50 nm or less.

6. The perpendicular magnetic recording medium of claim 1, wherein the soft underlayer comprises:
a first soft underlayer; and
a second soft underlayer arranged closer to the perpendicular magnetic recording layer than the first soft underlayer, the second soft underlayer having a smaller saturation magnetization than the first soft underlayer.

7. The perpendicular magnetic recording medium of claim 6, wherein the thickness of the second soft underlayer is less than the thickness of the first soft underlayer.

8. The perpendicular magnetic recording medium of claim 7, wherein the thickness of the second soft underlayer is 1 nm or more and 50 nm or less.

9. The perpendicular magnetic recording medium of claim 7, wherein the entire thickness of the soft underlayer is 200 nm or less, and the thickness of the second soft underlayer closer to the perpendicular magnetic recording layer is 50 nm or less.

10. The perpendicular magnetic recording medium of claim 1, wherein the soft underlayer is formed of a ferromagnetic substance or the combination of an antiferromagnetic substance and a ferromagnetic substance.

11. The perpendicular magnetic recording medium of claim 10, wherein the soft underlayer comprises one or more alloys selected from the group consisting of a NiFe-based alloy, an Fe-based alloy and a Co-based alloy.

12. The perpendicular magnetic recording medium of claim 11, wherein the soft underlayer comprises an alloy selected from the group consisting of NiFe, NiFeNb, NiFeCr, and a ternary or quaternary alloy thereof, FeAlSi, FeTaC, FeTaN, and a quaternary alloy thereof, and CoFe, CoZrNb, CoZrTa, and a ternary or quaternary alloy thereof.

13. The perpendicular magnetic recording medium of claim 1, wherein the perpendicular magnetic recording layer comprises a ferromagnetic substance formed of a Co-based and/or an Fe-based alloy.

14. The perpendicular magnetic recording medium of claim 13, wherein the Co-based and/or the Fe-based alloy is selected from the group consisting of CoCrPtX (X═Nb, B, Ta, SiOx, O) alloy and an ordered L10 type FePt alloy.

15. The perpendicular magnetic recording medium of claim 1, further comprising a perpendicular alignment underlayer arranged between the soft underlayer and the perpendicular magnetic recording layer.

16. A perpendicular magnetic recording medium comprising:
a perpendicular magnetic recording layer provided on a substrate; and
a soft underlayer formed between the substrate and the perpendicular magnetic recording layer, wherein
the soft underlayer comprises a plurality of soft underlayers having different saturation magnetizations, and the entire thickness of the soft underlayers is 200 nm or less while the thickness of the soft underlayer closer to the perpendicular magnetic recording layer is 50 nm or less.

17. The perpendicular magnetic recording medium of claim 16, wherein at least one of the soft underlayers has a magnetization easy axis in a radial direction.

18. The perpendicular magnetic recording medium of claim 16, wherein the soft underlayer is formed of a ferromagnetic substance or the combination of an antiferromagnetic substance and a ferromagnetic substance.

19. The perpendicular magnetic recording medium of claim 18, wherein the soft underlayer comprises an alloy selected from the group consisting of a NiFe-based alloy, an Fe-based alloy and a Co-based alloy.

20. The perpendicular magnetic recording medium of claim 19, wherein the soft underlayer comprises an alloy selected from the group consisting of NiFe, NiFeNb, NiFeCr, and a ternary or quaternary alloy thereof, FeAlSi, FeTaC, FeTaN, and a quaternary alloy thereof, and CoFe, CoZrNb, CoZrTa, and a ternary or quaternary alloy thereof.

21. The perpendicular magnetic recording medium of claim 16, wherein the perpendicular magnetic recording layer comprises a ferromagnetic substance formed of a Co-based and/or an Fe-based alloy.

22. The perpendicular magnetic recording medium of claim 21, wherein the Co-based and/or the Fe-based alloy is selected from the group consisting of CoCrPtX (X═Nb, B, Ta, SiOx, O) alloy and an ordered L10 FePt alloy.

23. The perpendicular magnetic recording medium of claim 16, further comprising a perpendicular alignment underlayer arranged between the soft underlayer and the perpendicular magnetic recording layer.
